(19) United States
(12) Patent Application Publication
(10) Pub. No.: US 2025/0139072 A1
(43) Pub. Date: May 1, 2025

(54) DATA QUERY METHOD AND APPARATUS

(71) Applicant: Beijing Volcano Engine Technology Co., Ltd., Haidian District (CN)

(72) Inventors: Zhaowei Huang, Beijing (CN); Junling Du, Beijing (CN); Yuanpu Ding, Beijing (CN)

(21) Appl. No.: 18/818,466

(22) Filed: Aug. 28, 2024

(30) Foreign Application Priority Data
Oct. 26, 2023 (CN) 202311406446.X

(51) Int. Cl. G06F 16/22; G06F 16/2455

(52) U.S. Cl. CPC G06F 16/221; G06F 16/24552

(57) ABSTRACT

The present application discloses a data query method, comprising: receiving a data query request, the data query request being used for querying data from a columnar storage system which applies object storage technology, the columnar storage system comprising an index file and a data file which are stored individually. After receiving the data query request, the index file is obtained based on the data query request, i.e., the whole index file may be obtained when receiving the data query request. Afterwards, a storage range in the data file of target data which matches the data query request determined based on the index file, and further, a network input and output (IO) is called to read the target data stored in the storage range. As such, it can reduce the number of calls to the network IO and further improves the efficiency of querying data from the columnar storage system.

### CROSS-REFERENCE TO RELATED APPLICATION(S)

This application claims priority to Chinese Application No. 202311406446.X filed in Oct. 26, 2023, the disclosure of which is incorporated herein by reference in its entirety.

### FIELD

The present disclosure relates to the field of data processing, and in particular, to a data query method and apparatus.

### BACKGROUND

With the development of computer technology, massive data have emerged, coupled with a wide range of data storage techniques. The columnar storage technique is one of widely used data storage techniques at present. The so-called columnar storage technique refers to data storage that takes columns as the storage granularity when storing table data. A data storage system that uses the columnar storage technique for data storage can also be referred to as a columnar storage system.

In some scenarios, the data query efficiency of columnar storage systems is rather low.

Therefore, there is an urgent need for a solution that can solve the above problems.

### SUMMARY

In order to solve or at least partly solve, the above technical problems, embodiments of the present disclosure provide a data query method and apparatus.

In a first aspect, an embodiment of the present disclosure provides a data query method, the method comprising:
receiving a data query request, the data query request being used for querying data from a columnar storage system which applies object storage technology, the columnar storage system comprising an index file and a data file which are stored individually;
obtaining the index file based on the data query request;
determining, based on the index file, a storage range in the data file of target data which matches the data query request; and
calling a network input and output to read the target data stored in the storage range.

Optionally, obtaining the index file based on the data query request comprises:
calling the network input and output to read the index file based on the data query request.

Optionally, obtaining the index file based on the data query request comprises:
obtaining, based on the data query request, the index file which is pre-saved in a local cache.

Optionally, the target data comprises data carried in a plurality of data pages, and the method further comprises:
processing the target data based on the data query request to obtain a query result corresponding to the data query request, the query result comprising data carried in part of the plurality of data pages; and
storing, in a local cache, an identifier of each data page in the part of data pages and data carried each data page, respectively.

Optionally, the index file comprises a base index file and an additional index file, and the base index file comprises base index information corresponding to each column block in the data file, and wherein base index information corresponding to each column block is used for indicating a storage location corresponding to a respective data page in the each column block, and the additional index file comprises additional index information corresponding to at least one column block in the data file, and additional index information corresponding to each of the at least one column block is used for determining, in a query phase, whether data to be queried is located at the each column block.

Optionally, the base index file further comprises:
a storage location of the data file and a storage location of the additional index file.

In a second aspect, an embodiment of the present application provides a data query apparatus, the apparatus comprising:
a receiving unit configured to receive a data query request, the data query request being
used for querying data from a columnar storage system which applies object storage technology, the columnar storage system comprising an index file and a data file which are stored individually;
an obtaining unit configured to obtain the index file based on the data query request;
a determining unit configured to determine, based on the index file, a storage range in the data file of target data which matches the data query request; and
a reading unit configured to call a network input and output to read the target data stored in the storage range.

Optionally, the obtaining unit is configured to:
call a network input and output to read the index file based on the data query request.

Optionally, the obtaining unit is configured to:
obtain, based on the data query request, the index file which is pre-saved in a local cache.

Optionally, the target data comprises data carried in a plurality of data pages, and the apparatus further comprises:
a processing unit configured to process the target data based on the data query request to obtain a query result corresponding to the data query request, the query result comprising data carried in part of the plurality of data pages; and
a caching unit configured to store an identifier of each data page in the part of data pages and data carried in each data page in a local cache correspondingly.

Optionally, the index file comprises a base index file and an additional index file, and the base index file comprises base index information corresponding to each column block in the data file, and wherein base index information corresponding to each column block is used for indicating a storage location corresponding to a respective data page in the each column block, and the additional index file comprises additional index information corresponding to at least one column block in the data file, and additional index information corresponding to each of the at least one column block is used for determining, in a query phase, whether data to be queried is located at the each column block.

Optionally, the base index file further comprises:
a storage location of the data file and a storage location of the additional index file.

In a third aspect, an embodiment of the present application further provides an electronic device, the device comprising a processor and a memory;
the processor being configured to execute instructions stored in the memory to cause the device to perform the method as described in the first aspect.

In a fourth aspect, an embodiment of the present application provides a computer readable storage medium, comprising instructions which instruct a device to perform the method as described in the first aspect.

In a fifth aspect, an embodiment of the present application further provides a computer program product which, when running on a computer, causes the computer to perform the method as described in the first aspect.

Compared with the prior art, the embodiments of the present application have the following advantages:

The embodiments of the present application provide a data query method, comprising: receiving a data query request, the data query request being used for querying data from a columnar storage system which applies object storage technology, the columnar storage system comprising an index file and a data file which are stored individually. After receiving the data query request, the index file is obtained based on the data query request, i.e., the whole index file may be obtained when receiving the data query request. Afterwards, a storage range in the data file of target data which matches the data query request determined based on the index file, and further, a network input and output (IO) is called to read the target data stored in the storage range. Since the index file may be obtained based on the data query request after receiving the data query request, and only one call to the network IO is needed to obtain the whole index file, i.e., only one call to the network IO is needed to determine the storage range, rather than calling the network IO several times in the prior art. Since each call to the network IO for obtaining data will generate certain delay, the present solution reduces the number of calls to the network IO and further improves the efficiency of querying data from the columnar storage system.

### BRIEF DESCRIPTION OF THE DRAWINGS

To illustrate the technical solution in the embodiments of the present application or in the prior art more clearly, a brief introduction is presented below to the accompanying drawings to be used to the description of the embodiment or the prior art. It is obvious that the accompanying drawings in the following description are merely some of the embodiments disclosed in the present application. Those of ordinary skill in the art may further derive other figures from these accompanying drawings without the exercise of any inventive skill.

FIG. 1 illustrates a schematic diagram of a storage file provided by embodiments of the present disclosure;

FIG. 2 illustrates a flowchart of a data query method provided by embodiments of the present disclosure;

FIG. 3 illustrates a schematic diagram of a storage file provided by embodiments of the present disclosure; and

FIG. 4 illustrates a schematic diagram of a structure of a data query apparatus provided by embodiments of the present disclosure.

### DETAILED DESCRIPTION OF EMBODIMENTS

To enable those skilled in the art to better understand the solution of the present application, a clear and complete description will be presented below to the technical solution of the embodiments of the present disclosure in conjunction with the accompanying drawings. Apparently, the embodiments to be described are merely part rather than all of the embodiments of the present disclosure. Furthermore, all other embodiments obtained by those of ordinary skill in the art without the exercise of any inventive skill based on the embodiments of the present disclosure belong to the protection scope of the present application.

The inventors of the present application have found, through research, that if a columnar storage system applies an object storage technique, then the data query efficiency for the columnar storage system is rather low.

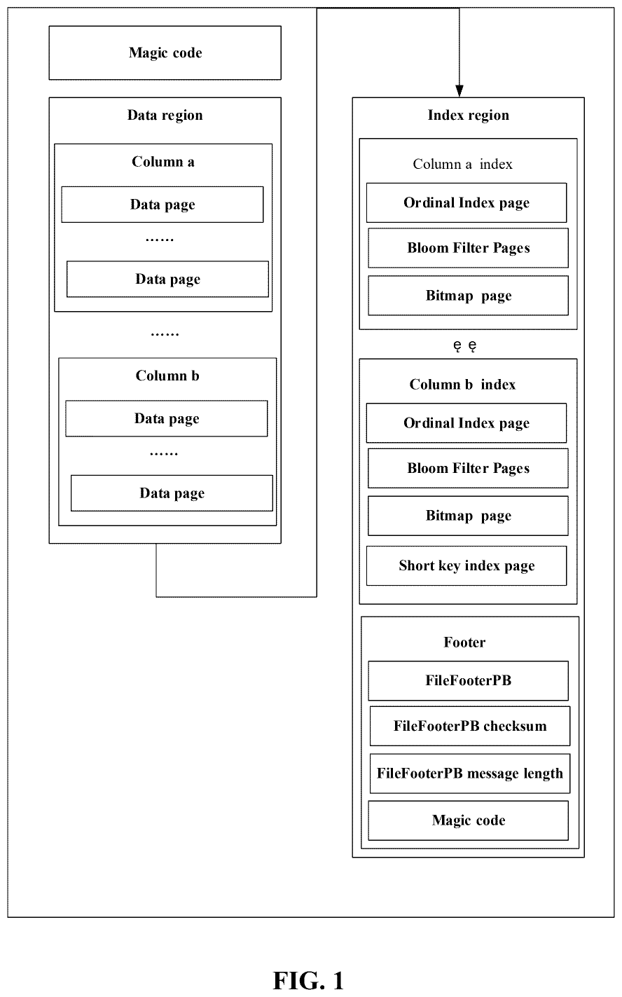

For the sake of understanding, a possible data storage format of the columnar storage system is first introduced. With reference to FIG. 1, this figure is a schematic diagram of a storage file provided by embodiments of the present application. As shown in FIG. 1, the storage file comprises magic code, a data region and an index region.

The magic code is used for identifying a file format and a version.

The data region is used for storing data information of respective columns. The data region comprises at least one column, each of the columns comprises a plurality of data pages, and the data page is used for carrying data information. The page is a basic unit of encoding and compression.

The index region comprises indexes corresponding to the respective columns, wherein for each column, its index may comprise a base index and an additional index, and base index information corresponding to each column is used for indicating a row number associated with each data page in the each column and a storage location corresponding to each data page. The base index may correspond to an ordinal index page. Additional base information corresponding to each column is used in a query phase for determining whether data to be queried is located in the column. In FIG. 1, the additional index may correspond to Bloom filter pages and a bitmap page.

The index region further comprises a short key index page. The short key index is a sparse index of the short key, which is not described here in detail.

The index region further comprises a footer. The footer comprises: a file footer pointer buffer (FileFooterPB), a 4-byte FileFooterPB checksum, a 4-byte FileFooterPB message length, and an 8-byte magic code, wherein FileFooterPB is used for defining metadata information of the file.

When a columnar storage system applies an object storage technique, the data query efficiency for the columnar storage system is rather lower. The object storage technique is a network storage architecture that uses a flat data organization form and supports access to data based on Hypertext Transfer Protocol (HTTP).

Illustration is presented below in conjunction with specific examples.

Suppose the Structured Query Language (SQL) for data queries is: select sum (b) from t where 1000>a and a>100. Its treatment process is as follows:

1. reading Footer.

This step will call the network input and output 3 times. Specifically,

First of all, the size of the whole file is read, recorded as file_length, wherein a network IO needs to be called once. Secondly, [file_length−12, file_length) data is read to obtain the size of Footer, recorded as footer_size, wherein the network IO needs to be called once. In addition, [file_length−footer_size, file_length) data is read to obtain the whole Footer, wherein the network IO needs to be called once.

2. reading Short Key Index based on the location of Footer.

This step will call the network IO once.

3. determining a storage range in the file of to-be-queried data based on Short Key

### Index.

4. reading Ordinal Indexes of AB columns.

This step will call the network IO twice, wherein reading Ordinal Index of A column and reading Ordinal Index of B column each need to call the network IO once. If the quantity of columns involved in the SQL statement is m, this step will call 2*m network IOs.

5. determining a storage range for reading data page based on Ordinal Index and a range of row numbers, and reading the hit data page.

Suppose n data pages are hit, then 2*n network IOs will be called.

Therefore, (3+1+2+2*n) network IOs will be called under this scenario.

Furthermore, if the indexes of Bitmap page and BloomFilter page need to be read, the network IO needs to be called additionally.

Since each call to the network IO to obtain data will have a certain delay, the more times the network IO is called, the lower the efficiency of the data query.

The network IO refers to input and output operations of a computer system that involve network communications.

To solve the foregoing problems, the present solution provides a data query method, which can reduce the number of network IO calls and thereby improve the efficiency of querying data from the aforementioned columnar storage system.

Various non-limiting implementations of the present application are described in detail below in conjunction with the accompanying drawings.

### Example Method

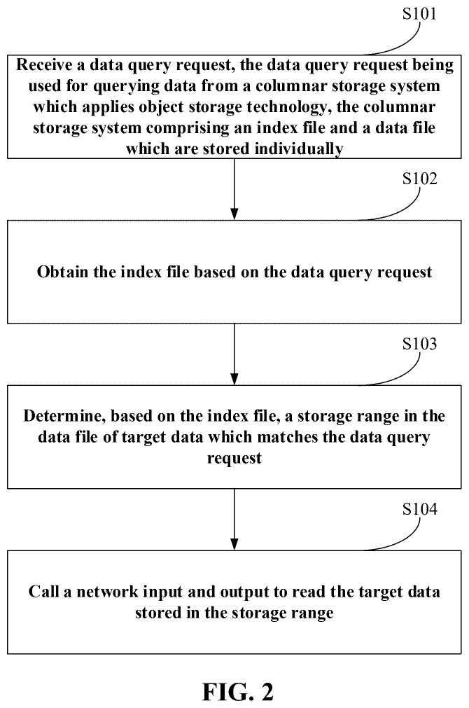

With reference to FIG. 2, this figure is a schematic flowchart of a data query method provided by embodiments of the present application. The data query method provided by embodiments of the present application may be performed by a client or a server, which is not limited in embodiments of the present disclosure.

In this embodiment, the method may, for example, comprise the following S101-S104.

S101: a data query request is received, the data query request being used for querying data from a columnar storage system which applies object storage technology, the columnar storage system comprising an index file and a data file which are stored individually.

In one example, the data query request may be an SQL statement. S101 may, in a specific implementation, receive the SQL statement input by a user via a human-computer interface.

In embodiments of the present disclosure, the columnar storage system no longer stores data and indexes in the same file as in the conventional technique, but stores the data and indexes individually, storing the data in the data file and storing the indexes in the index file.

In one example, the data file comprises a plurality of column blocks, each of which may comprise at least one data page. Accordingly, the index file comprises a footer and index information corresponding to each column block. In one specific example, for a certain column block, its index information may comprise base index information, wherein base index information corresponding to each column block is used for indicating a storage location corresponding to a respective data page in each column block. In another specific example, for a certain column block, its index information may further comprise additional index information, the additional index information being used for determining, in a query phase, whether data to be queried is located at the each column block.

In a further specific example, when a certain column block comprises both corresponding base index information and corresponding additional index information, the aforesaid index file may comprise a base index file and an additional index file, wherein the base index file comprises base index information corresponding to each column block in the data file, and the additional index file comprises additional index information corresponding to at least one column block in the data file. In this way, it is possible to avoid causing a large index file by storing both the base index information and the additional index information in the index file.

In one example, the aforesaid base index file may further comprise a storage location of the data file and a storage location of the additional index file. In this way, after the base index file is obtained, the storage location of the data file and the storage location of the additional index file may be determined, so as to facilitate subsequently reading the data file based on the storage location of the data file and/or reading the additional index file based on the storage location of the additional index file.

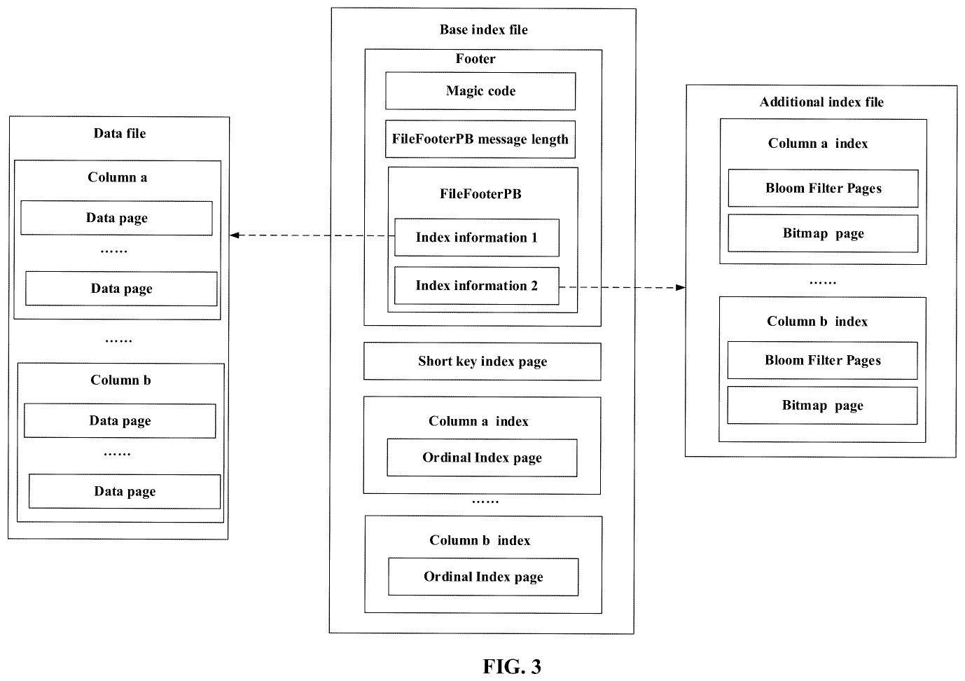

With respect to the data file, the base index file and the additional index file, reference may be made to FIG. 3 for an understanding. FIG. 3 is a schematic diagram of a storage file provided by embodiments of the present application. For a content stored in the data file, it is the same as the content stored in the data region as shown in FIG. 1, which is not repeated herein. The contents stored in the base index file and in the additional index file are essentially the same as the contents stored in the index region as shown in FIG. 1, except for the following differences:

1. FileFooterPB further comprises index information 1 which indicates the storage location of the data file and index information 2 which indicates the storage location of the additional index file.

2. The footer in the base index file is located at a beginning portion of the file, while the footer in FIG. 1 is located at an ending portion of the index region.

Of course, FIG. 3 has been depicted to facilitate the understanding of the present solution. In one example, footer in the base index file may also be located at the ending portion of the file, which is not limited in embodiments of the present application.

S102: the index file is obtained based on the data query request.

In one example, after receiving the data query request, the index file may be read by calling a network IO. For example, an http message may be generated for requesting to read the index file, and the http message is sent, thereby realizing the reading of the index file.

In a further example, the network IO may be called in advance to read the index file, and the index file may be saved in a local cache. Thus, after the data query request is received, the index file may be directly read from the local cache, thereby effectively improving the efficiency of reading the index file.

Whether the network IO is called to read the index file after receiving a data query request, or the network IO is called in advance to read the index file, reading the index file requires only one call to the network IO. After obtaining the index file, S103 may be performed to determine a storage range in the data file of target data which matches the data query request. In other words, in the embodiments of the present application, only one call to the network IO is needed during the process for determining the storage range of the target data in the data file, whereas in the prior art, as described above, steps 1-4 need to be performed in order to determine the storage range of the target data in the data file, which involves several calls to the network IO. Therefore, the number of calls to the network IO can be effectively reduced using the present solution.

S103: based on the index file, a storage range in the data file of target data which matches the data query request is determined.

In the embodiments of the present application, target data which matches the data query request may be understood as data which can determine a query result. That is, a query result can be obtained by processing the target data. The target data is not necessarily the query result itself, but the query result may be part of data in the target data or may be obtained by processing the target data, which is not limited in the embodiments of the present application.

In one example, if the data query request involves a certain column, then Short Key Index may be extracted from the index file, and a range of row numbers corresponding to the target data is determined based on the Short Key Index, wherein the range of row numbers corresponding to the target data may be understood to include the range of row numbers corresponding to the aforesaid certain column of the target data. Further, index information of the column may be extracted from the index file, for example, base index information of the column is extracted, so that a data page storing the target data is determined based on the range of row numbers and the index information of the column, and further the storage range of the target data in the data file is obtained. For example, the corresponding data page storing the target page may be determined based on the range of row numbers and the index information of the column, and further the storage range of the data page in the data file may be obtained based on the index information of the column. The storage range mentioned here may be characterized, for example, by a start storage location and an end storage location.

S104: a network input and output is called to read the target data stored in the storage range.

After the storage range of the target data in the data file is determined, the network IO may further be called to read the target data stored in the storage range in the data file. For example, data between the start storage location and the end storage location is read, wherein the target data being read may be complete data of a certain column or columns. For example, with respect to SQL: select b from t where 1000>a and a>100, the data being read may be complete data of column a and column b.

As is clear from the foregoing description, with the solution of the embodiments of the present application, the index file may be obtained based on the data query request after receiving the data query request, and only one call to the network IO is needed to obtain the whole index file, i.e., only one call to the network IO is needed to determine the storage range, rather than calling the network IO several times in the prior art. Since each call to the network IO for obtaining data will generate certain delay, the present solution reduces the number of calls to the network IO and further improves the efficiency of querying data from the columnar storage system.

In one example, after reading the data, the target data may be further processed in conjunction with the data query request, thereby obtaining a query result corresponding to the data query request. For example, after reading data of column a and column b, a b value meeting the condition 1000>a and a>100 may be processed as a processing result, based on values of respective rows of column a.

In one example, the target data may be carried by a plurality of data pages, and the query result may comprise data carried in part of the plurality of data pages. In this case, the query result may further be stored in a local cache in the form of key-value. Specifically, an identifier of each data page in the part of data pages and data carried each data page are stored in a local cache, respectively, wherein the identifier of the data page is recorded as key, and the data carried in the data page is recorded as value. Table 1 is provided below for ease of understanding.

TABLE 1

| key | value |
|---|---|
| tablet-t1-segment-s-col-c-page-p1 | data carried in page 1 of column |
| | c in table s in tablet t1 |
| tablet-t1-segment-s-col-c-page-p2 | data carried in page 2 of column |
| | c in table s in tablet t1 |
| tablet-t2-segment-m-col-b-page-p1 | data carried in page 1 of column |
| | b in table m in tablet t2 |

Wherein tablet is the minimum data management unit corresponding to the columnar storage system, e.g., a tablet may include several segments, and a segment may correspond to a table. In other words, a tablet may include several tables.

In other words, data may be stored in a local cache with data pages at the granularity of a data page, instead of storing data in the local cache at the granularity of an entire column block. Thus, this reduces the granularity of the data cache and helps to improve the performance of the cache. Accordingly, when querying based on locally cached data, it is also possible to query based on the data page granularity, which is conducive to improving the query efficiency.

### Example Device

Based on the method provided by the foregoing embodiments, an apparatus is further provided by an embodiment of the present application. The apparatus is described below in conjunction with the accompanying drawings.

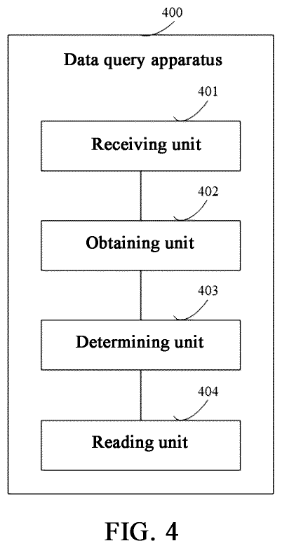

With reference to FIG. 4, this figure is a structural schematic diagram of a data query apparatus provided by an embodiment of the present application. The apparatus 400 may, for example, comprise: a receiving unit 401, an obtaining unit 402, a determining unit 403 and a reading unit 404.

The receiving unit 401 is configured to receive a data query request, the data query request being used for querying data from a columnar storage system which applies object storage technology, the columnar storage system comprising an index file and a data file which are stored individually;

The obtaining unit 402 is configured to obtain the index file based on the data query request;

The determining unit 403 is configured to determine, based on the index file, a storage range in the data file of target data which matches the data query request;

The reading unit 404 is configured to call a network input and output to read the target data stored in the storage range.

Optionally, the obtaining unit 402 is configured to:
call a network input and output to read the index file based on the data query request.

Optionally, the obtaining unit 402 is configured to:
obtain, based on the data query request, the index file which is pre-saved in a local cache.

Optionally, the target data comprises data carried in a plurality of data pages, and the apparatus further comprises:
a processing unit configured to process the target data based on the data query request to obtain a query result corresponding to the data query request, the query result comprising data carried in part of the plurality of data pages; and
a caching unit configured to an identifier of each data page in the part of data pages and data carried in each data page in a local cache correspondingly.

Optionally, the index file comprises a base index file and an additional index file, and the base index file comprises base index information corresponding to each column block in the data file, and wherein base index information corresponding to each column block is used for indicating a storage location corresponding to a respective data page in the each column block, and the additional index file comprises additional index information corresponding to at least one column block in the data file, and additional index information corresponding to each of the at least one column block is used for determining, in a query phase, whether data to be queried is located at the each column block.

Optionally, the base index file further comprises:
a storage location of the data file and a storage location of the additional index file.

Since the apparatus 400 is an apparatus corresponding to the data query method provided by the foregoing method embodiments, specific implementation of the respective units of the apparatus 400 belong to the same concept of the foregoing method embodiments. Thus, for the specific implementation of the respective units of the apparatus 400, reference may be made to the relevant description of the foregoing method embodiments, which is not repeated here.

An embodiment of the present application further provides an electronic device, which may comprise a processor and a memory;

The processor is configured to execute instructions stored in the memory to cause the device to perform the data query method provided by the foregoing method embodiments.

An embodiment of the present application provides a computer readable storage medium, storing instructions which instruct a device to perform the data query method provided by the foregoing method embodiments.

An embodiment of the present application further provides a computer program product which, when running on a computer, causes the computer to perform the data query method provided by the foregoing method embodiments.

Other embodiments of the present application would be readily envisaged by those skilled in the art upon consideration of the specification and practice of the invention disclosed herein. The present application is intended to cover any variations, uses, or adaptations of the present application that follow the general principles of the present application and include common knowledge or customary technical means in the art which is not disclosed in the present disclosure. The specification and embodiments are to be regarded as exemplary only, and the true scope and spirit of the present application is indicated by the following claims.

It is to be understood that the present application is not limited to the precise structure described above and shown in the accompanying drawings, but various modifications and changes may be made without departing from the scope. The scope of the present application is defined by the appended claims only.

What has been described above is merely preferred embodiments of the present application, rather than for limiting the present application. Any modifications, equivalent replacements, improvements and the like within the spirit and principles of the present application should fall within the protection scope of the present application.

1. A data query method, comprising:
receiving a data query request, the data query request being used for querying data from a columnar storage system which applies object storage technology, the columnar storage system comprising an index file and a data file which are stored individually, wherein the data file is stored at a data region, and the index file is stored at an index region different from the data region;
obtaining the index file based on the data query request;
determining, based on the index file, a storage range in the data file of target data which matches the data query request; and
calling a network input and output to read the target data stored in the storage range.

2. The method of claim 1, wherein obtaining the index file based on the data query request comprises:
calling the network input and output to read the index file based on the data query request.

3. The method of claim 1, wherein obtaining the index file based on the data query request comprises:
obtaining the index file which is pre-saved in a local cache based on the data query request.

4. The method of claim 1, wherein the target data comprises data carried in a plurality of data pages, and the method further comprises:
processing the target data based on the data query request to obtain a query result corresponding to the data query request, the query result comprising data carried in a part of the plurality of data pages; and
storing an identifier of each data page in the part of data pages and data carried in each data page in a local cache correspondingly.

5. The method of claim 1, wherein the index file comprises a base index file and an additional index file, and
the base index file comprises base index information corresponding to each column block in the data file, and
wherein the base index information corresponding to each column block is used for indicating a storage location corresponding to a respective data page in the each column block, and
the additional index file comprises additional index information corresponding to at least one column block in the data file, and
additional index information corresponding to each of the at least one column block is used for determining, in a query phase, whether data to be queried is located at the each column block.

6. The method of claim 5, wherein the base index file further comprises:
a storage location of the data file and a storage location of the additional index file.

7. An electronic device, comprising:
a processor; and
a memory,
wherein the processor is configured to execute instructions stored in the memory to cause the device to:
receive a data query request, wherein the data query request is used for querying data from a columnar storage system which applies object storage technology, and the columnar storage system comprises an index file and a data file which are stored individually, wherein the data file is stored at a data region, and the index file is stored at an index region different from the data region;
obtain the index file based on the data query request;
determine, based on the index file, a storage range in the data file of target data which matches the data query request; and
call a network input and output to read the target data stored in the storage range.

8. The electronic device of claim 7, wherein the instructions to obtain the index file based on the data query request comprise instructions to:
call the network input and output to read the index file based on the data query request.

9. The electronic device of claim 7, wherein the instructions to obtain the index file based on the data query request comprise instructions to:
obtain the index file which is pre-saved in a local cache based on the data query request.

10. The electronic device of claim 7, wherein the target data comprises data carried in a plurality of data pages.

11. The electronic device of claim 10, wherein the instructions further comprise instructions to:
process the target data based on the data query request to obtain a query result corresponding to the data query request, the query result comprising data carried in a part of the plurality of data pages; and
store an identifier of each data page in the part of data pages and data carried in each data page in a local cache correspondingly.

12. The electronic device of claim 7, wherein the index file comprises a base index file and an additional index file, and
the base index file comprises base index information corresponding to each column block in the data file, and
wherein the base index information corresponding to each column block is used for indicating a storage location corresponding to a respective data page in the each column block, and
the additional index file comprises additional index information corresponding to at least one column block in the data file, and
additional index information corresponding to each of the at least one column block is used for determining, in a query phase, whether data to be queried is located at the each column block.

13. The electronic device of claim 12, wherein the base index file further comprises:
a storage location of the data file and a storage location of the additional index file.

14. A non-transitory computer readable storage medium comprising instructions, wherein the instructions, when executed by a device, cause the device to:
receive a data query request, wherein the data query request is used for querying data from a columnar storage system which applies object storage technology, and the columnar storage system comprises an index file and a data file which are stored individually, wherein the data file is stored at a data region, and the index file is stored at an index region different from the data region;
obtain the index file based on the data query request;
determine, based on the index file, a storage range in the data file of target data which matches the data query request; and
call a network input and output to read the target data stored in the storage range.

15. The non-transitory computer readable storage medium of claim 14, wherein the instructions to obtain the index file based on the data query request comprise instructions to:
call the network input and output to read the index file based on the data query request.

16. The non-transitory computer readable storage medium of claim 14, wherein the instructions to obtain the index file based on the data query request comprise instructions to:
obtain the index file which is pre-saved in a local cache based on the data query request.

17. The non-transitory computer readable storage medium of claim 14, wherein the target data comprises data carried in a plurality of data pages.

18. The non-transitory computer readable storage medium of claim 17, wherein the instructions further comprise instructions to:
process the target data based on the data query request to obtain a query result corresponding to the data query request, the query result comprising data carried in a part of the plurality of data pages; and
store an identifier of each data page in the part of data pages and data carried in each data page in a local cache correspondingly.

19. The non-transitory computer readable storage medium of claim 14, wherein the index file comprises a base index file and an additional index file, and
the base index file comprises base index information corresponding to each column block in the data file, and
wherein the base index information corresponding to each column block is used for indicating a storage location corresponding to a respective data page in the each column block, and
the additional index file comprises additional index information corresponding to at least one column block in the data file, and
additional index information corresponding to each of the at least one column block is used for determining, in a query phase, whether data to be queried is located at the each column block.

20. The non-transitory computer readable storage medium of claim 19, wherein the base index file further comprises:
a storage location of the data file and a storage location of the additional index file.
